(19) United States
(12) Patent Application Publication
(10) Pub. No.: US 2001/0055385 A1
(43) Pub. Date: Dec. 27, 2001

(54) Optical microphone

(76) Inventors: Yoshiharu Taniguchi, Kumoyama Tottori-Shi (JP); Masahiro Yamamoto, Kumoyama Tottori-Shi (JP); Alexander Paritsky, Modiin (IL); Alexander Kots, Ashdod (IL)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/726,199

(22) Filed: Nov. 29, 2000

(30) Foreign Application Priority Data
May 11, 1998 (JP) 10-127678

(51) Int. Cl. H04M 1/00; H04M 9/00

(52) U.S. Cl. 379/433.03

(57) ABSTRACT

There is disclosed an optical microphone which reduces hindrance to the vibration of a membrane with respect to the input elastic wave, to thereby obtain a linear output current fluctuation with respect to the input elastic wave. Specifically, the total area of an outlet window 8 for performing irradiation and an inlet window 7 for receiving light is made equal to or less than 5% of the area of a membrane 5. And the vertical sectional shape of a light-guiding portion 9 includes a multidimensional function curve portion of 1.2 dimension or more. Moreover, the sectional shape is such that if an angle formed between the substrate and the tangent of the sectional shape at an intersection of the curve and a normal with respect to the substrate respectively extended from the light emission element and the light-receiving element is designated as α, the critical angle of the light-guiding portion material becomes larger than 180-2α.

### BACKGROUND OF THE INVENTION

1. Field of the Invention

The present invention relates to microphones used for car telephones, mobile phones, microphones used for audio microphones or microphones used for crime prevention intruder detectors for detecting an intruder by catching a pressure change in the air inside the house due to the intruder.

2. Description of the Related Art

Condenser microphones including elecret microphones have conventionally overwhelming usage rate in car telephones, mobile phones and audio fields. On the contrary, optical microphones for detecting membrane displacement due to the air vibration by an electric signal have a small structure, low power consumption, high sensitivity, high S/N ratio, and a selective frequency characteristic in audio elastic wave bands, and hence have advantages in that a filter in the post circuit is not necessary, or that noise with respect to extrinsic electromagnetic waves is less, and recently it is under development as a noticeable new technology.

FIG. 3 shows a typical structure of this optical microphone. Normally, a red or infrared LED produced by a semiconductor process, composed mainly of silicon, germanium and gallium arsenic is used for a light emission element 1. This light emission element 1 is fixed on a substrate 3 by an adhesive or the like, and electrically connected therewith from a face opposite to the substrate 3 with a wire bonding technology using an extra fine metallic wire. A phototransistor or a photodiode produced by the semiconductor process, having sensitivity to electromagnetic waves emitted by the light emission element 1 is used for a light-receiving element 2, which is also electrically connected with the substrate 3 by the wire bonding in the similar manner to the light emission element 1.

In order to prevent chemical deterioration due to outside gas and physical deterioration due to dirt, dust, foreign matter or the like, the circumference of these light emission element 1, light-receiving element 2 and wire is filled with a resin transparent to the electromagnetic waves emitted by the light emission element 1 or ceramic materials such as glassy materials. Moreover, in order to efficiently collect electromagnetic waves emitted from the light emission element 1 to an outlet window 8, a coating 12 is formed on the outer surface of this filling material by a material not transparent to the electromagnetic waves. The light emission element 1 and the light-receiving element 2 are isolated by a nontransparent isolation wall 10 within the filling material, with the coating 12, the isolation wall 10 and the filling material forming a light-guiding portion 9. Above the light emission element 1, the light-receiving element 2 and the light-guiding portion 9, there is arranged a metallic membrane 5 or a membrane 5 comprising a resin coated with electromagnetic wave-reflective material.

The electromagnetic waves emitted by the light emission element 1 is directly reflected by the light-guiding portion 9 formed of the filling material, the coating 12 and the isolation wall 10, or reflected on the inside thereof, and irradiated onto the membrane 5 from the outlet window 8. The electromagnetic waves reflected by the membrane 5 reaches the light-receiving element 2 from the inlet window 7, through the light-guiding portion 9 on the opposite side, putting the isolation wall 10 therebetween. The light-receiving element 2 converts the electromagnetic waves into electric signals such as electric current or voltage supplied to the incident energy, and outputs the electric signals.

Here, it has been found that there is a relation as shown in FIG. 4 between the distance 6 from the membrane 5 to the inlet/outlet windows 7, 8, and the electric signal output. In order to read the vertical displacement magnitude of the membrane 5 linearly by the electric signal, and to read slight displacement magnitude as a large change in the electric signal, it is desirable that the inclination of the function curve shown in FIG. 4 be more steady and larger. In FIG. 4, the area 13 is a portion corresponding to the inclination, and an operating point essentially to be expected.

When it is desired to obtain a more steady and larger inclination in FIG. 4, one of the unnegligible elements is a shape of the filling agent located below the membrane 5. In a condition that the membrane 5 is vibrating due to elastic waves, it is desired that negative pressure with respect to the membrane 5 from a part beneath the membrane 5 be as small as possible, in order not to disturb the vibration of the membrane 5, and that any object be not disposed as much as possible beneath the membrane 5. With the optical microphone, however, since the light-guiding portion 9 is constructionally located beneath the membrane 5, this causes an increase in the negative pressure, resulting in hindrance to obtaining more steady and larger inclination in FIG. 4. This influence becomes more conspicuous as the distance between the inlet/outlet window 7, 8 and the membrane 5 becomes closer, and as the size of the filling agent becomes larger. However, if the distance between the inlet/outlet window 7, 8 for electromagnetic waves and the membrane 5 increases, the operation area of the microphone is shifted to the area 14 in FIG. 4, and hence the performance of the microphone initially desired cannot be realized. With the structure in FIG. 3, the total area of the outlet window 8 and the inlet window 7 is set to be 5% or less of the membrane 5.

As a solution therefor, there is proposed a light-guiding portion structure shown in FIG. 5. However, there is still a problem in that a column or a square pillar relatively smaller and finer than the light emission element 1 and the light-receiving element 2 must be molded, and the yield may be deteriorated due to insufficient strength at the time of molding. Moreover, the angle of view into the outlet window 8 from the light emission element 1 and the angle of view into the inlet window 7 from the light-receiving element 2 are made small, causing deterioration in the electric signal obtained from the light-receiving element 2, that is, deterioration in sensitivity.

The object of the present invention is to make the constructional element small, which hinders vibrations of the membrane, and to obtain large signal output proportional to the displacement magnitude of the membrane.

### SUMMARY OF THE INVENTION

The present invention is characterized in that the total area of the outlet window for performing irradiation and the inlet window for receiving light is made equal to or less than 5% of the membrane area, and the vertical sectional shape of an electromagnetic wave-guiding portion of the optical microphone includes a concave multidimensional function curve of 1.2 dimension or more. Moreover, in the present invention, the sum of a double value of an angle formed between the substrate and the tangent of the curve above the light emission element and the light-receiving element, and the critical angle of the electromagnetic wave-guiding portion material becomes larger than 180 degrees.

### BRIEF DESCRIPTION OF DRAWINGS

FIG. 1 is a longitudinal sectional view of an optical microphone according to the present invention.

FIG. 2 is a graph showing that the vertical sectional shape of the optical microphone shown in FIG. 1 includes a 1.2 or more dimensional curve.

FIG. 3 is a longitudinal sectional view of a conventional optical microphone.

FIG. 4 is a graph showing a relation between a distance from an outlet window 8 or an inlet window 7 to a membrane 5, and an electric signal output.

FIG. 5 is a longitudinal sectional view of a structural plan in which measures for not hindering vibrations of the membrane 5 are taken.

In the above respective figures, reference symbol 1 denotes a light emission element, 2 denotes a light-receiving element, 3 denotes a substrate, 4 denotes a membrane support, 5 denotes a membrane, 7 denotes an inlet window, 8 denotes an outlet window, 6 denotes a distance between the inlet/outlet windows 7, 8 and the membrane 5, 9 denotes a transparent resin, 10 denotes an isolation wall, 11, 12 and 15 denote coatings, 13 denotes an optical microphone operation area, and 14 denotes an optical microphone operation area.

### DESCRIPTION OF THE PREFERRED EMBODIMENTS

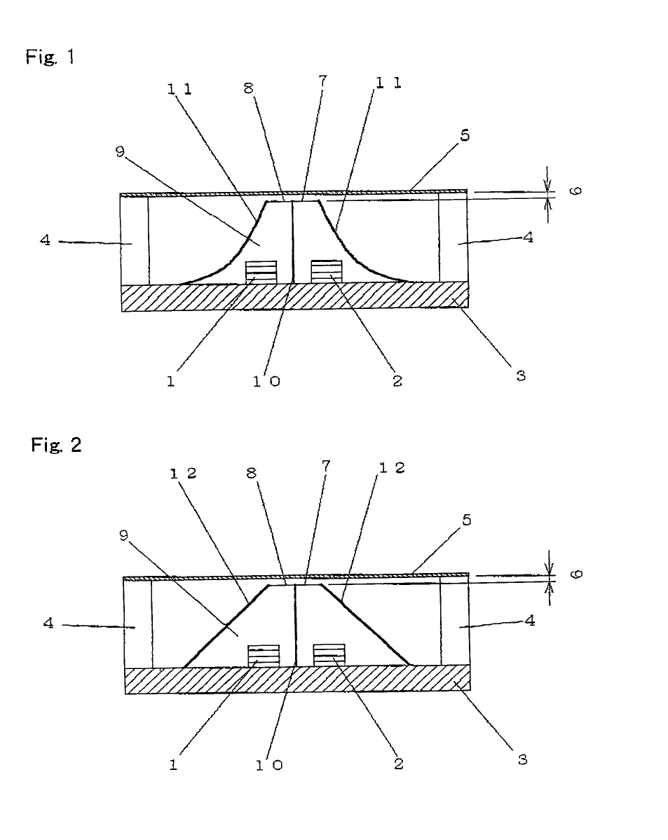

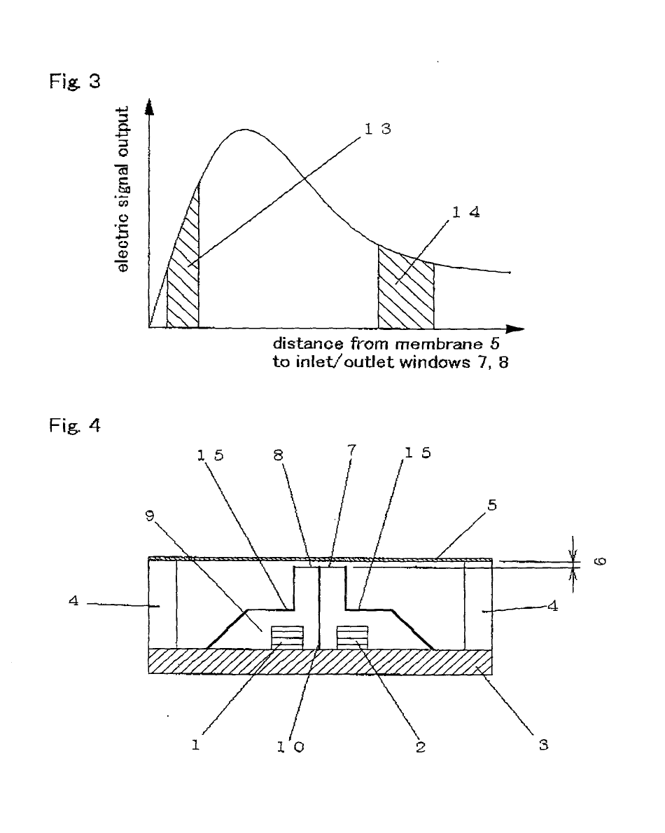

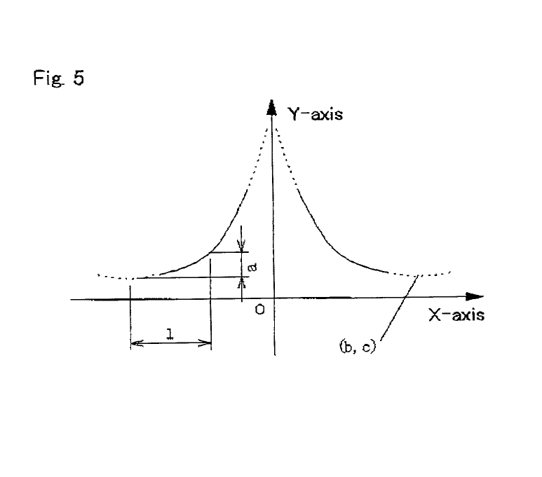

FIG. 1 shows a longitudinal sectional view of an optical microphone according to an embodiment of the present invention. This optical microphone is constructed such that a light emission element 1 and a light-receiving element 2 mounted on a substrate 3 are sealed with a filling material, and an isolation wall 10 is disposed between the light emission element 1 and the light-receiving element 2 within the sealed portion. A coating 11 is formed in an area other than the area serving as an outlet window 8 and an inlet window 7 on the outer surface of the sealing portion, and a light-guiding portion 9 is formed of the filling material, the isolation wall 10 and the coating 11. Above the outlet window 8 and the inlet window 7, an electromagnetic wave-reflective membrane 5 that vibrates due to sound, pressure or the like is held by a membrane support 4.

The electromagnetic wave from the light emission element 1 is emitted via the outlet window 8, is reflected by the membrane 5, and reaches the light-receiving element 2 via the inlet window 7. When the membrane position is shifted due to the vibration, the reflection position also moves, to thereby change the output of the light-receiving element. Sound, pressure or the like is detected by reading this output.

In this optical microphone, as shown in FIG. 1, the total area of the outlet window 8 and the inlet window 7 is made equal to or less than 5% of the membrane area. And the vertical sectional shape of the light-guiding portion 9 of the optical microphone is made to be a shape including a concave multidimensional function curve of 1.2 dimension or more. If there is a concave, 1.2 dimension or more curve portion in the outer rim of the light-guiding portion 9, a wide space can be ensured in the vicinity of the membrane 5, the outlet window 8 and the inlet window 7. This enables reduction of adverse effects due to the negative pressure with respect to the vibration of the membrane 5. Moreover, since the outer rim of the light-guiding portion 9 is constituted by a continuous curve, the air in the vicinity thereof smoothly moves, to thereby improve the linearity of the signal output.

FIG. 2 shows only a curved portion forming a longitudinal section of the light-guiding portion 9 shown in FIG. 1. As shown in FIG. 2, when an optional point is designated as a two-dimensional origin, to set the X-axis and Y-axis, in the curve, there are included curves that can be shown by the following expressions: a(x−b)²=(y−c), and a(x+b)²=(y−c), wherein a, b and c are optional real numbers. If a curve including a concave quadratic function exists in the section of the light-guiding portion 9 of the membrane, vibrations of the membrane are not hindered.

In FIG. 1, a quadratic function is used for the formation of the curve. However, if the curved portion is not a 1 dimension or less function, that is, if n>1 in the expression of, for example, a(x−b)ⁿ=(y−c), some effects can be expected, and if n is at least 1.2 or more, it is more effective.

The incident angle when the light emitted vertically from the light emission element 1 is reflected by the curve and reaches the outlet window 8 will become 180-2α, if the angle formed between the tangent of the curve at the reflected point and the substrate is designated as α. It this incident angle is smaller than the critical angle of the light-guiding portion material, the reflected light is emitted outside via the outlet window 8. That is to say, if the sum of 2α and the critical angle is larger than 180 degrees, the light emitted vertically from the light emission element 1 is emitted outside via the outlet window 8. If an LED is used as the light emission element, the quantity of light of the LED is largest in the vertical direction. Moreover, the same is applied for the light-receiving element 2 according to the Fermat's principle, and the light emitted via the outlet window enters via the inlet window and effectively reaches the light-receiving element.

The refractive index of the light-guiding member takes a value of around 1.5. If the refractive index is designated as 1.5, the critical angle becomes 42 deg. Hence, if the angle formed between the substrate and the tangent of the curve at an intersection of the curve and a normal with respect to the substrate respectively extended from the light emission element and the light-receiving element is larger than 69 deg., the light emitted vertically from the light emission element 1 is emitted outside via the outlet window 8, and can be effectively utilized.

By using the method described in this devices a more linear output and higher sensitivity can be obtained, compared to the conventional optical microphone, and hence industrial value in this field can be recognized.

What is claimed is:

1. An optical microphone having a light emission element, a light-receiving element, a membrane, and a structure such that electromagnetic waves emitted from the light emission element is irradiated to the membrane, and the electromagnetic waves reflected by the membrane are converted into electric signals such as electric current or voltage, thereby detects the displacement of the membrane due to air vibration with said electric signal,
wherein the total area of an outlet window and an inlet window is made equal to or less than 5% of the membrane area, and
wherein the vertical sectional shape of an electromagnetic wave-guiding portion includes a concave multidimensional function curve of 1.2 dimension or more.

2. An optical microphone according to claim 1, wherein the sum of
a double value of an angle formed between the substrate and the tangent of a vertical sectional shape of the electromagnetic wave-guiding portion vertically above the light-receiving element and
the critical angle of the electromagnetic wave-guiding portion material
becomes larger than 180 degrees.
